(19) United States
(12) Patent Application Publication
(10) Pub. No.: US 2018/0224887 A1
(43) Pub. Date: Aug. 9, 2018

(54) APPARATUS AND METHOD FOR ASYNCHRONOUS EVENT TIMESTAMPING

(71) Applicant: QUALCOMM Incorporated, San Diego, CA (US)

(72) Inventor: Radu PITIGOI-ARON, San Jose, CA (US)

(21) Appl. No.: 15/851,453

(22) Filed: Dec. 21, 2017

Related U.S. Application Data
(60) Provisional application No. 62/455,402, filed on Feb. 6, 2017.

(51) Int. Cl. G06F 1/14; H04L 12/40

(52) U.S. Cl. CPC G06F 1/14; H04W 52/0251; H04L 12/40032

(57) ABSTRACT

Methods and apparatuses are described for obtaining a timestamp of an interface event. In one configuration, a host receives an in-band interrupt (IBI) from a sensor. The IBI indicates an interface event occurring at a first time on the sensor. The host issues a first host-initiated event at a second time after the first time in response to the IBI and starts a first host count of cycles of a host clock, wherein a start of the first host count of cycles is concurrent with issuing the first host-initiated event. The host further detects whether reception of the IBI was delayed. If the reception of the IBI was not delayed, the host obtains the timestamp of the interface event based on a first set of variables. If the reception of the IBI was delayed, the host obtains the timestamp of the interface event based on a second set of variables.

### CROSS-REFERENCE TO RELATED APPLICATION

This application claims priority to and the benefit of U.S. Provisional Patent Application No. 62/455,402, entitled “APPARATUS AND METHOD FOR ASYNCHRONOUS EVENT TIMESTAMPING” filed on Feb. 6, 2017, the entire contents of which is incorporated herein by reference.

### BACKGROUND

### Field

The present disclosure relates generally to electronic devices, and more particularly to methods, apparatus, and systems for timestamping asynchronous events.

### Background

Serial interfaces have become the preferred method for digital communication between integrated circuit (IC) devices in various apparatus. For example, mobile communications equipment may perform certain functions and provide capabilities using IC devices that include radio frequency transceivers, cameras, display systems, user interfaces, controllers, storage, and the like. General-purpose serial interfaces known in the industry, including the Inter-Integrated Circuit (I2C or I²C) serial bus and its derivatives and alternatives, including interfaces defined by the Mobile Industry Processor Interface (MIPI) Alliance, such as the Improved Inter-Integrated Circuit (I3C) interface and the Radio Frequency Front End (RFFE) interface.

Modern-day mobile devices contain many sensors. Usually, a data processing unit, controller, host device, or master device (hereinafter referred to as a “controller” or a “host controller”) is provided to receive and process data collected by sensors or slave units (hereinafter referred to a “sensor”). To conserve power, the controller is regularly placed into a sleep state when no data is being transferred from the sensors to the controller.

Two methods of transferring data from sensors to a controller are commonly utilized. In the first method, which is known as the asynchronous method, a sensor with available data to transfer notifies the controller by issuing a signal (e.g., a Data Ready Interrupt (DRI) signal through a dedicated DRI pin for certain known systems), which wakes up the controller, and then the sensor transfers the data when the controller is ready. In the second method, which is known as the synchronous method, the controller wakes up from the sleep state spontaneously at predetermined time intervals, polls the sensors, and receives from the sensors whatever data is present at the sensors. The synchronous method is more energy efficient in a device comprising multiple sensors because data transfers from more than one sensor may be consolidated into a single poll and transfer session.

In some systems, it is known that sensors might provide data on an interface or bus in a random or unexpected manner (i.e., an essentially “asynchronous” manner), whether the system as a whole is intentionally operating in an asynchronous data sampling mode or in a synchronous data sampling mode where random events might occur on the interface or bus. In such instances, it is desirable for the host controller to be able to acquire accurate time-of-occurrence information of when sensors or slave devices provide data in random or unexpected manners. Moreover, in some systems, when there is a need to confirm the accuracy of a synchronous functionality, the host controller may require the sensor or slave device to initiate an in-band interrupt (IBI) request at a synchronized event and provide a timestamp.

### SUMMARY

Embodiments disclosed herein provide systems, methods, and apparatuses that facilitate obtaining a timestamp of an interface event.

In an aspect of the disclosure, a method performed at a host controller for obtaining a timestamp of an interface event occurring on an interface, includes receiving an in-band interrupt (IBI) from a sensor, the IBI indicating an occurrence of an interface event caused by the sensor, the interface event occurring at a first time on the sensor, issuing a first host-initiated event on the interface at a second time after the first time in response to the received IBI and starting a first host count of cycles of a host controller clock, wherein a start of the first host count of cycles is concurrent with issuing the first host-initiated event, and detecting whether reception of the IBI was delayed. If the reception of the IBI was not delayed, the method includes obtaining the timestamp of the interface event occurring at the first time based at least in part on a first sensor clock count, a clock period of the sensor, and a host controller timestamp of the second time. If the reception of the IBI was delayed, the method includes obtaining the timestamp of the interface event occurring at the first time based at least in part on the first host count of cycles of the host controller clock, the first sensor clock count, a second sensor clock count, a clock frequency of the host controller, and the host controller timestamp of the second time.

In an aspect, if the reception of the IBI was not delayed, obtaining the timestamp includes receiving the first sensor clock count from the sensor, wherein the first sensor clock count is a first sensor count of cycles of an internal sensor clock from the first time to the second time, calculating a timestamp delay as a product of the first sensor clock count and the clock period of the sensor, and obtaining the timestamp by subtracting the timestamp delay from the host controller timestamp of the second time.

In another aspect, if the reception of the IBI was delayed, obtaining the timestamp includes issuing a second host-initiated event on the interface at a third time after the second time, receiving the first sensor clock count from the sensor, wherein the first sensor clock count is a first sensor count of cycles of an internal sensor clock from the first time to the second time, receiving the second sensor clock count from the sensor, wherein the second sensor clock count is a second sensor count of cycles of the internal sensor clock from the second time to the third time, calculating a timestamp delay according to a relationship: the timestamp delay is equal to the first sensor clock count divided by the second sensor clock count multiplied by the first host count of cycles of the host controller clock divided by the clock frequency of the host controller, and obtaining the timestamp by subtracting the timestamp delay from the host controller timestamp of the second time.

In a further aspect, the second host-initiated event on the interface is issued at the third time according to a relationship: the third time minus the second time is greater than or equal to one-hundred times the clock period of the sensor. Each of the first host-initiated event and the second host-initiated event may include a predetermined hardware event known to both the host controller and the sensor.

In an aspect, the detecting whether reception of the IBI was delayed includes obtaining a time elapsed from a last stop condition on the interface to when the IBI was received, comparing the time elapsed to a reference time, detecting that the reception of the IBI was not delayed if the time elapsed is greater than or equal to the reference time, and detecting that the reception of the IBI was delayed if the time elapsed is less than the reference time.

In another aspect of the disclosure, a host controller device configured to obtain a timestamp of an interface event occurring on an interface, includes an interface coupled to a sensor via a transport medium and at least one processing circuit coupled to the interface. The at least one processing circuit is configured to receive an in-band interrupt (IBI) from the sensor, the IBI indicating an occurrence of an interface event caused by the sensor, the interface event occurring at a first time on the sensor, issue a first host-initiated event on the interface at a second time after the first time in response to the received IBI and start a first host count of cycles of a host controller clock, wherein a start of the first host count of cycles is concurrent with issuing the first host-initiated event, and detect whether reception of the IBI was delayed. If the reception of the IBI was not delayed, the at least one processing circuit is configured to obtain the timestamp of the interface event occurring at the first time based at least in part on a first sensor clock count, a clock period of the sensor, and a host controller timestamp of the second time. If the reception of the IBI was delayed, the at least one processing circuit is configured to obtain the timestamp of the interface event occurring at the first time based at least in part on the first host count of cycles of the host controller clock, the first sensor clock count, a second sensor clock count, a clock frequency of the host controller device, and the host controller timestamp of the second time.

In a further aspect of the disclosure, a processor-readable storage medium having one or more instructions which, when executed by at least one processing circuit, cause the at least one processing circuit to receive, at a host controller, an in-band interrupt (IBI) from a sensor, the IBI indicating an interface event caused by the sensor occurring on an interface, the interface event occurring at a first time on the sensor, issue a first host-initiated event on the interface at a second time after the first time in response to the received IBI and start a first host count of cycles of a host controller clock, wherein a start of the first host count of cycles is concurrent with issuing the first host-initiated event, and detect whether reception of the IBI was delayed. If the reception of the IBI was not delayed, the one or more instructions cause the at least one processing circuit to obtain a timestamp of the interface event occurring at the first time based at least in part on a first sensor clock count, a clock period of the sensor, and a host controller timestamp of the second time. If the reception of the IBI was delayed, the one or more instructions cause the at least one processing circuit to obtain the timestamp of the interface event occurring at the first time based at least in part on the first host count of cycles of the host controller clock, the first sensor clock count, a second sensor clock count, a clock frequency of the host controller, and the host controller timestamp of the second time.

In yet another aspect of the disclosure, a host controller device for obtaining a timestamp of an interface event occurring on an interface, includes means for receiving an in-band interrupt (IBI) from a sensor, the IBI indicating an occurrence of an interface event caused by the sensor, the interface event occurring at a first time on the sensor, means for issuing a first host-initiated event on the interface at a second time after the first time in response to the received IBI and starting a first host count of cycles of a host controller clock, wherein a start of the first host count of cycles is concurrent with issuing the first host-initiated event, means for detecting whether reception of the IBI was delayed, and means for obtaining the timestamp of the interface event. If the reception of the IBI was not delayed, the means for obtaining the timestamp is configured to obtain the timestamp of the interface event occurring at the first time based at least in part on a first sensor clock count, a clock period of the sensor, and a host controller timestamp of the second time. If the reception of the IBI was delayed, the means for obtaining the timestamp is configured to obtain the timestamp of the interface event occurring at the first time based at least in part on the first host count of cycles of the host controller clock, the first sensor clock count, a second sensor clock count, a clock frequency of the host controller, and the host controller timestamp of the second time.

### BRIEF DESCRIPTION OF THE DRAWINGS

FIG. 1 is block diagram illustrating an exemplary mobile device in which the presently disclosed methods and apparatus may be implemented.

FIG. 2 is block diagram illustrating an exemplary hardware environment in which the presently disclosed methods and apparatus may be implemented.

FIG. 3 illustrates an exemplary timeline diagram showing sensor and host controller timestamping according to a first asynchronous mode.

FIG. 4 illustrates a timeline diagram showing a simplified timeline diagram of the timelines of FIG. 3.

FIG. 5 illustrates an exemplary timeline diagram showing sensor and host controller timestamping according to a second asynchronous mode.

FIG. 6 is a diagram illustrating an algorithm for evaluating a slave's clock frequency.

FIG. 7 is a diagram illustrating an algorithm for evaluating a time exhausted between an asynchronous event and a first master-initiated event.

FIG. 8 is a diagram illustrating a first operation for evaluating a timestamp of an asynchronous interface event occurring near a first master-initiated event.

FIG. 9 is a diagram illustrating a second operation for evaluating a timestamp of an asynchronous interface event where the reception of an interrupt request from a slave is significantly delayed.

FIG. 10 is a flowchart illustrating an exemplary method for obtaining a timestamp of an interface event occurring on an interface.

FIG. 11 illustrates an exemplary host controller or master device according to the present disclosure.

FIG. 12 is a diagram illustrating a simplified example of a hardware implementation for a host controller.

### DETAILED DESCRIPTION

Aspects of the disclosed methods and apparatus are disclosed in the following description and related drawings directed to specific aspects. Alternate aspects may be devised without departing from the scope of the present disclosure. Additionally, well known elements may not be described in detail or may be omitted so as not to obscure the relevant details of the disclosure.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

The terminology used herein is for the purpose of describing particular aspects only and is not intended to be limiting of aspects of the disclosure. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device (e.g., a server or device). It will be recognized that various actions described herein can be performed by specific circuits (e.g., application specific integrated circuits), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Example of an Apparatus with Multiple Device Subcomponents and an Exemplary Hardware Environment

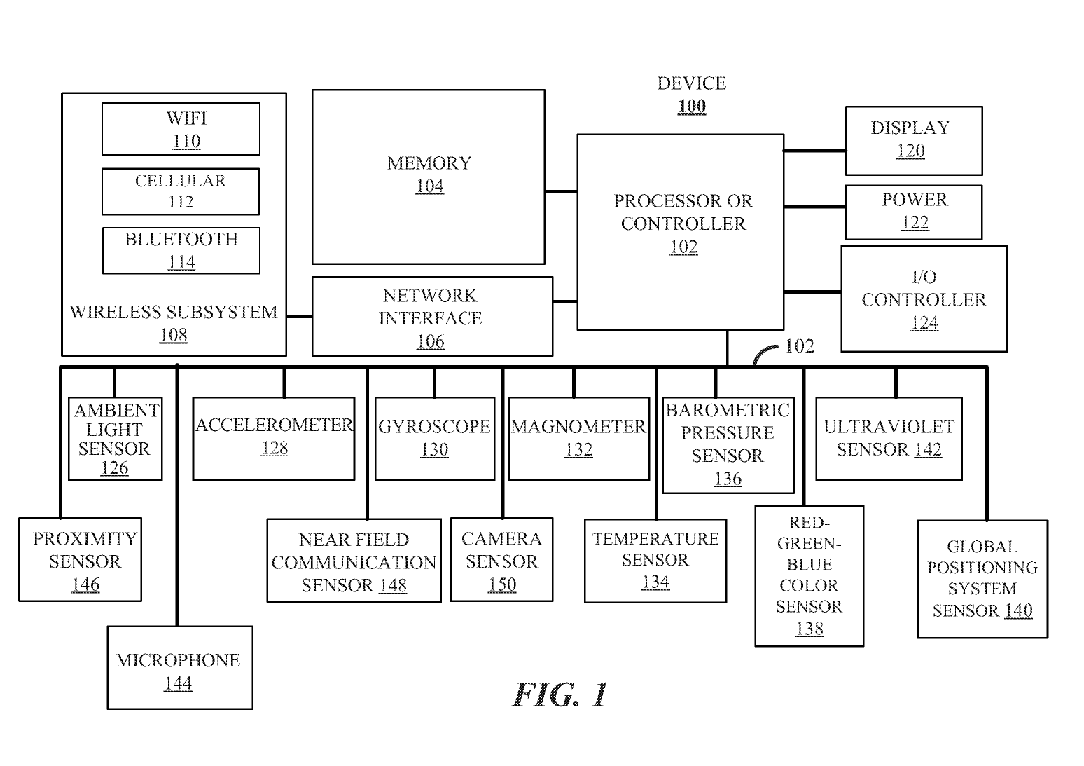

FIG. 1 is a block diagram illustrating an exemplary mobile device in which aspects of the present disclosure may be practiced. A device 100 may include one or more processors 102, a memory device 104, an I/O controller 124, and a network interface 106. The device 100 may also include a number of device sensors coupled to one or more buses or signal lines further coupled to the processor 102. It should be appreciated that the device 100 may also include a display 120, a user interface (e.g., a keyboard, a touch-screen, or similar devices), a power device 122 (e.g., a battery), as well as other components typically associated with electronic devices. In some aspects, the device 100 may be a mobile or non-mobile device. Herein the terms “processor” and “data processing unit” are used interchangeably.

The device (e.g., device 100) can include sensor devices such as an ambient light sensor (ALS) device 126, an accelerometer 128, a gyroscope 130, a magnetometer 132, a temperature sensor device 134, a barometric pressure sensor device 136, a red-green-blue (RGB) color sensor device 138, a Global Positioning System (GPS) sensor device 160, an ultra-violet (UV) sensor device 142, a microphone 144, a proximity sensor device 146, a near field communication (NFC) sensor device 148, and/or a camera sensor device 150. In some aspects, multiple cameras are integrated or accessible to a device. For example, a mobile device may have at least a front and rear mounted camera. In some aspects, other sensors may also have multiple installations or versions.

The memory device 104 may be coupled to the processor 102 to store instructions for execution by the processor 102. In some aspects, the memory device 104 is non-transitory. The memory device 104 may also store one or more models or modules to implement aspects described below. The memory device 104 may also store data from integrated or external sensor devices.

The network interface 106 may also be coupled to a number of subsystems 108 (e.g., a Bluetooth network 114, a WiFi network 110, a Cellular network 112, or other networks) to transmit and receive data streams through a link to/from a network, or may be a wired interface for direct connection to networks (e.g., the Internet, Ethernet, or other systems). The device 100 may include one or more local area network transceivers connected to one or more antennas (not shown). The local area network transceiver may include suitable devices, hardware, and/or software for communicating with and/or detecting signals to/from access points (Aps), and/or directly with other devices within a network. In one aspect, the local area network transceiver may include a WiFi (e.g., Institute of Electrical and Electronics Engineers (IEEE) specifications 802.11x) communication system suitable for communicating with one or more access points.

The device 100 may also include one or more wide area network transceiver(s) that may be connected to one or more antennas. The wide area network transceiver may include suitable devices, hardware, and/or software for communicating with and/or detecting signals to/from other devices within a network. In one aspect, the wide area network transceiver may include a Code-Division Multiple Access (CDMA) communication system suitable for communicating with a CDMA network of base stations; however in other aspects, the communication system may include another type of cellular telephony network or femtocells, such as, for example, Time-Division Multiple Access (TDMA), Long-Term Evolution (LTE), LTE Advanced, Wideband Code-Division Multiple Access (WCDMA), Universal Mobile Telecommunications System (UMTS), 4G, 5G, or Global System for Mobile Communications (GSM). Additionally, any other type of networking technologies may be used, for example, WiMax (IEEE 802.16), Ultra Wide Band, ZigBee, Universal Serial Bus (USB), etc.

Additionally, the device 100 may be a mobile device, a cell phone, a personal digital assistant, a mobile computer, a wearable device (e.g., a head mounted display, virtual reality glasses, etc.), a robot navigation system, a tablet, a personal computer, a laptop computer, or any type of device that has processing and/or communication capabilities. As used herein, a mobile device may be any portable or movable device or machine that is configurable to acquire signals transmitted from, and transmit signals to, one or more communication devices or networks. Thus, by way of example, but not limitation, the device 100 may include a radio device, a cellular telephone device, a computing device, a personal communication system device, or other like movable communication equipped device, appliance, or machine. Any operable combination of the above are also considered a “mobile device.”

Furthermore, the mobile device 100 may communicate with a plurality of access points (APs), NodeBs, eNodeBs, base stations, etc. using radio frequency (RF) signals (e.g., 2.4 GHz, 3.6 GHz, and 4.9/5.0 GHz bands) and standardized protocols for the modulation of the RF signals and the exchanging of information packets (e.g., IEEE specifications 802.11x).

It should be appreciated that examples as will be hereinafter described may be implemented through the execution of instructions, such as instructions stored in the memory device 104 or other element, by the processor 102 of the device 100, and/or other circuitry of the device 100. Particularly, the circuitry of the device 100, including but not limited to the processor 102, may operate under the control of a program, routine, or the execution of instructions to execute methods or processes in accordance with aspects of the disclosure. For example, such a program may be implemented in firmware or software (e.g. stored in the memory device 104 and/or other locations) and may be implemented by processors, such as the processor 102, and/or other circuitry of the device 100. Further, it should be appreciated that the terms processor, microprocessor, circuitry, controller, etc., may refer to any type of logic or circuitry capable of executing logic, commands, instructions, software, firmware, functionality and the like.

Further, it should be appreciated that some or all of the functions, engines or modules described herein may be performed by the device 100 itself and/or some or all of the functions, engines or modules described herein may be performed by another system connected through the I/O controller 124 or the network interface 106 to the device 100. Thus, some and/or all of the functions may be performed by another system and the results or intermediate calculations may be transferred back to the device 100. In some aspects, such other devices may include a server configured to process information in real time or near real time. In some aspects, the other device is configured to predetermine the results, for example based on a known configuration of the device. Further, one or more of the elements illustrated in FIG. 1 may be omitted from the device 100. For example, one or more of the described sensor devices may be omitted in some aspects.

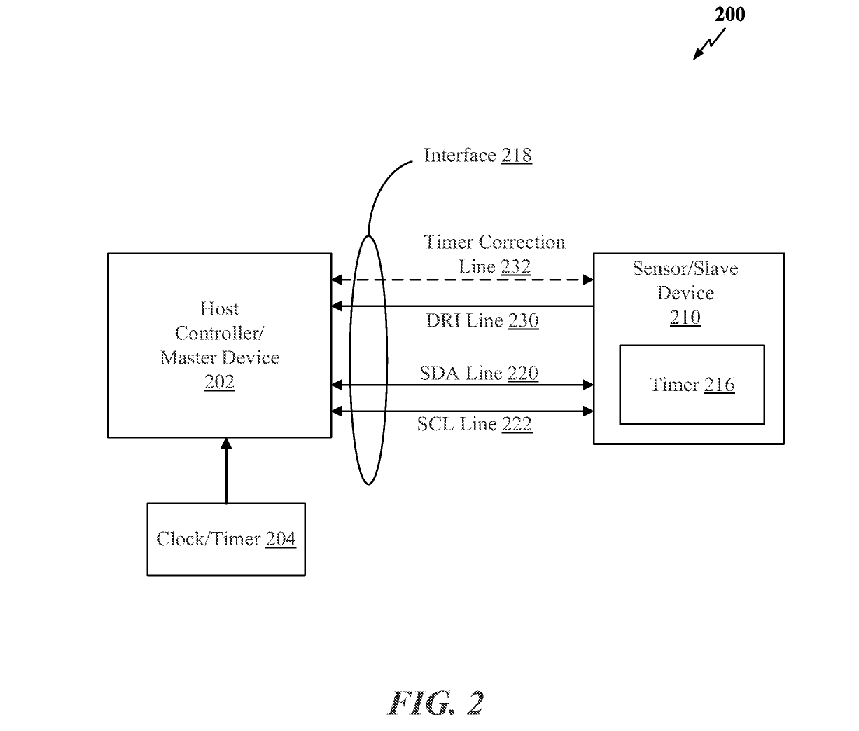

FIG. 2 is a block diagram illustrating an exemplary hardware environment 200 in which aspects of the present disclosure may be practiced. A host controller (or master) device 202 may be provided to receive and process data samples transferred from a sensor device 210 (or any other device that provides sampled data to a host or master), among other functions. In an example, the host controller device 202 may be implemented by or within the processor 102 of the device 100, but is not limited to such and may be implemented separate from the processor 102. The sensor device 210 may be a sensor device of any type, such as those described above, or any device that collects and sends sampled data. The presently disclosed aspects are not limited by the number of sensor devices, and more sensor devices (not shown) may be present. In some aspects, the host controller device 202 may be provided with a clock or timer signal from a clock 204. In other aspects, an internal clock generator may be embedded with the host controller device 202. The sensor device 210 includes an internal timer generator 216, which generates a timer signal for timing the collection and transmission of samples by the sensor device 210. A data connection, bus, or interface 218 links the processor 102 with the sensor device 210 and allows for, among other things, timing of the transfer of data between the host controller device 202 and the sensor device 210. In the example shown in FIG. 2, the data connection may be an Inter IC bus (I2C bus) or an I3C bus including a Serial Data (SDA) line 220 and a Serial Clock (SCL) line 222. Both SDA line 220 and SCL line 222 may be pulled up with pull-up resistors (not shown). The operation of I2C or I3C busses are known in the art, and will not to be described in detail here for sake of brevity.

The data connection may also be a universal asynchronous receiver/transmitter (UART) connection, a Serial Peripheral Interface (SPI) bus, a System Management Bus (SMBus), a Serial Low-power Inter-chip Media Bus (SLIMbus™), a SoundWire bus, or any other type of connection suitable for transferring data between a processor and a sensor device. In some aspects, the sensor device 210 may have a Data Ready Interrupt (DRI) pin, which may be connected to the host controller device 202 via a DRI line 230. In aspects where more than one sensor device is present, DRI lines from the multiple sensor devices may be multiplexed before being connected to the processor 102. In some other aspects, in addition to or instead of a DRI pin, the sensor device 210 may have a dedicated clock correction pin, which may be connected to the processor 102 via a clock correction line 232.

Two methods of transferring data from the sensor device 210 to the host controller device 202 may be utilized. In the first method, also known as the asynchronous method, the sensor device 210 with available data to transfer may notify the host controller device 202 by issuing a Data Ready Interrupt (DRI) signal onto the DRI line 230 through a dedicated DRI pin, which wakes the processor up from the sleep state, and transfers the data when the processor is ready for the data transfer. Alternatively, the hardware environment 200 may support in-band interrupt (IBI) capability. As such, in the asynchronous method, the sensor device 210 with available data to transfer may notify the host controller device 202 by issuing an IBI signal using signal wires of a serial bus (e.g., the SDA line 220 and the SCL line 222) instead of the dedicated DRI line 230, which wakes the processor up from the sleep state, and transfers the data when the processor is ready for the data transfer. In the second method, also known as the synchronous method, the host controller device 202 may wake up from the sleep state spontaneously at predetermined time intervals, and may poll the sensor device 210 to receive data.

### Exemplary Operating Environment for Obtaining a Timestamp of an Asynchronous Event

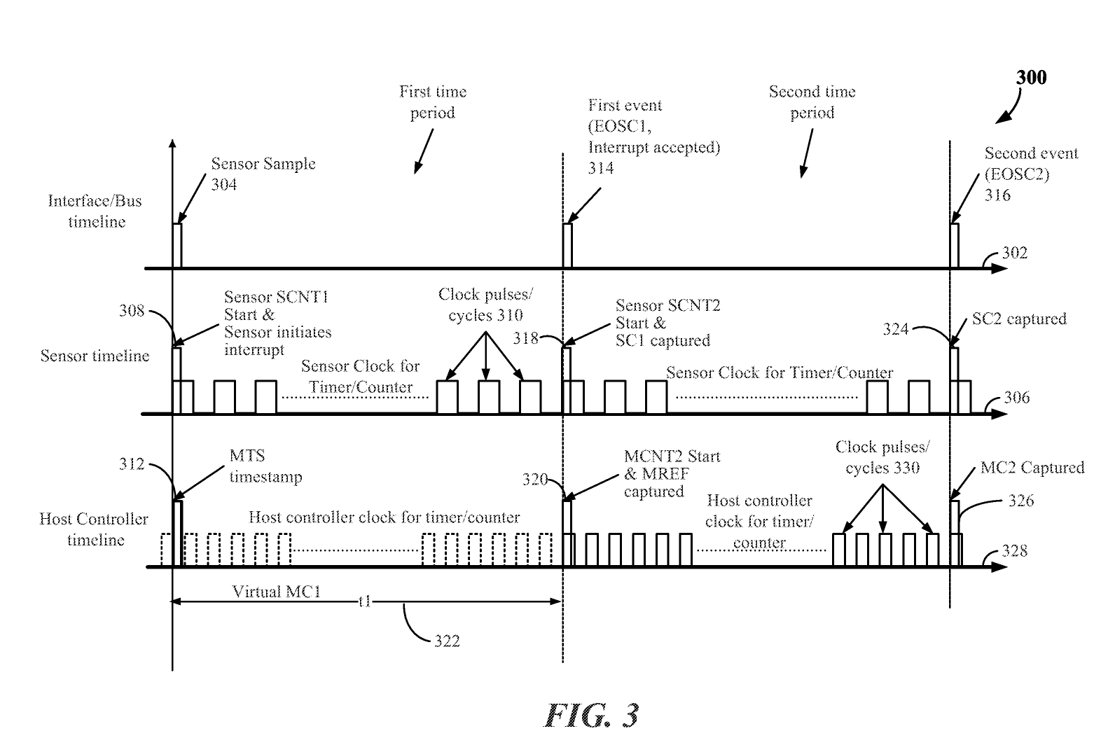

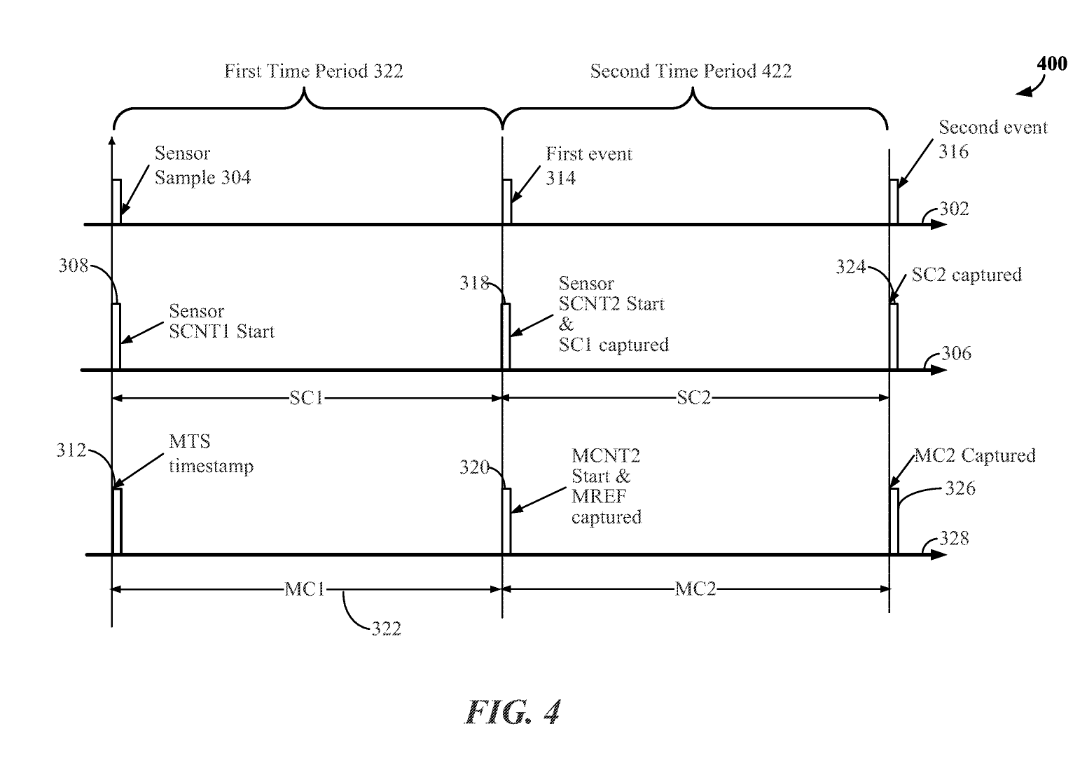

FIG. 3 illustrates an exemplary timeline diagram 300 showing sensor and host controller timestamping according to a first asynchronous mode (e.g., Async Mode 0). FIG. 4 illustrates a simplified timeline diagram 400 of the timelines of FIG. 3.

In particular, FIG. 3 illustrates processes during a relevant time period during and after a data transfer from a sensor to a host controller that allow the host controller to calculate the time at which the data sampling has taken place in a sensor despite that the controller itself may only be capable of measuring and determining the number cycles of its own clock signal. It is noted that a presumption in this example is that a sensor is able to transfer data within a time interval during which a sensor's timer or counter is able to make accurate and meaningful measurements (i.e., that a driving clock for the timer possesses a sufficiently stable frequency to substantially increment a timer or counter in a linear manner with respect to time).

The disclosed methodology of FIG. 3 employs the use of hardware events issued by the host controller (e.g., host controller device 202 in FIG. 2) on the bus or interface (e.g., interface 218 in FIG. 2) after an asynchronous event (e.g., random or unexpected event) on the bus occurs, such as a sensor sample. As may be seen at a top timeline 302, which illustrates a timeline of events on the bus or interface, a sensor sample 304, which may be a random or unexpected sample, occurs at a particular time on the timeline 302. In an aspect, the sensor issuing the sample 304 may be configured to start a counter or timer of an internal sensor clock when a particular event occurs (e.g., issuance of the sensor sample 304). Accordingly, an internal sensor timeline 306 shows that the sensor issuing the sample 304 starts a counter or timer (termed Sensor Count 1 or “SCNT1”) at the time of the sensor sample 304 being transmitted on the interface or bus. According to one example, the counter or timer SCNT1 (as well as the other timers to be discussed herein) may be implemented with a register, termed herein as a “timer register.” The start of the Sensor Count 1 (SCNT1) is illustrated by pulse 308. At this point, the pulses 310 of an internal clock of the sensor are counted in the sensor. Additionally, the sensor is configured to issue an interrupt or message to the host controller at the same time as the sensor sample 304 as also illustrated by the pulse 308 to indicate that the sensor has issued the sensor sample 304. The interrupt or message may be an interrupt request (IRQ) in I2C interfaces or an in-band interrupt (IBI) request in I3C interfaces.

According to an aspect, the host controller is configured to send first and second events 314 and 316 to the sensor separated in time on the bus or interface. An event may be predetermined or in some similar way mutually identifiable by the sensor and the host controller, and may be referred to as a hardware time synchronization event (HWSE) or a master-initiated hardware end-of-count/event (EOSC). According to some aspects, the events 314 and 316 may be configured to be edges of already defined events on either of the SDA or SCL lines, in the example of I2C or I3C interfaces. For example, two successive edges (either rising or falling) of the SCL line may constitute the events as part of a defined sequence of I2C or I3C transactions. In another example, two selected edges of an SCL clock on the SCL line may be predetermined as the identifiable hardware events, such as the first SCL line rising edges after an Acknowledgement (ACK) or a transition bit (T-bit) as one particular example. In another example, the interface events could be events that would occur on the bus or interface but are further independently identified as the interface events 314 and 316 by both the controller and the sensor. Based on reception of the events 314, 316, a sensor may transfer relevant time information to the host controller for use by the controller to determine or calculate an accurate time reference.

As indicated above, at the time of the sensor sample 304, the sensor may also issue an interrupt request (IRQ or IBI) as indicated by the pulse 308. If the interrupt request is accepted at the host controller, then the sensor is configured to record or store the first event 314 against its own timer or counter SC1 318. Also at the same time, the sensor will then start a second count of its internal clock (SCNT2) 318. Additionally, the host controller will record the first event 314 against its internal counter 320 on timeline 328 of the host controller. In particular, the host controller records a master reference count (termed “MREF”) against its own clock and then also starts a second count (e.g., MCNT2) of the host controller's clock pulses or cycles 330 at the same time.

At some predetermined time after the first event 314, the host controller issues the second hardware event 316 as shown in timeline 302. As may be also be seen in FIG. 3, the first event 314 may be issued after a first time period 322 (or time “t1”), which may also be considered a virtual first predetermined count of the host controller clock cycles (also referred to as a first Master Count (MC1)) as it is not counted but later calculated, as will be described in more detail below. The host controller will initiate the first event 314 on the bus or interface.

Upon issuance of the first event 314, the sensor will capture the count of SCNT1 and store or buffer a first sensor count (SC1), and indicative of the number of the internal sensor clock pulses or cycles occurring between the time of the sensor sample 304 on the interface and the first event 314. At the second event 316, the sensor captures or records a second sensor count (SC2) against its own counter 324, as shown in timeline 306. Additionally, the host controller records a second count of the host controller clock cycles (also referred to as a second Master Count (MC2)) at the occurrence of the second hardware event 316 against its own internal counter 326, as shown in timeline 328.

It is desirable for the host controller to be able to determine or recover a timestamp for an interface event, such as for the sensor sample 304. In an aspect, a host controller may determine a timestamp that corresponds to the time of the sensor sample 304 based on the counts that are sent from the sensor. For example, the sensor counts SC1 and SC2 may be sent on the interface or bus through means of the interrupt request such that the payload of the interrupt request contains the sensor counts SC1 and SC2. The sensor counts SC1 and SC2 may be sent by the sensor to the host controller on the interface after the occurrence of the second hardware event 316. The host controller may determine the timestamp that corresponds to the time of the sensor sample 304 based further on the counts in the host controller related to the issued first and second events 314, 316. To this end, the host controller determines a timestamp 312 (illustrated on timeline 328 of the host controller) corresponding to the sensor sample 304, which is termed herein as a Master Timestamp (MTS), and is expressed in time units of the host controller's internal clock. The determination of the MTS provides the host controller an accurate timing of the sensor sample 304 as it is was known internally by the sensor.

It is noted that the timelines, messages and events illustrated in FIG. 3 are implementable with any number of various interfaces and protocols with the messages sent across many different types of interfaces such that the methodology disclosed herein is not limited to any one type of interface. In a further aspect the methodology may be used on several or multiple interfaces as well as multiple interface protocols where several sensors may be synchronized against the internal time base of the host controller.

FIG. 4 illustrates a simplified timeline diagram 400 of the timelines of FIG. 3. Referring to FIG. 4, the relationships between the timing of each of the counts SC1, SC2, MC1, and MC2 may be more easily visualized. As described above, the host controller measures and determines the second Master Count (MC2) from a point 320 to another point 326 in terms of the number of cycles of its own internal clock signal. Assuming that both the sensor's internal clock signal is sufficiently stable over the duration of the first and second time periods (i.e., the first time period 322 from the time of the sensor sample 304 to the time of the first event 314 and the second time period 422 from the time of the first event 314 to the time of the second event 316), the first time period 322 may also be considered as a virtual first Master Count (MC1).

In an aspect of the disclosure, because the counts SC1, SC2, and MC2 may be known after the second event 316, the second time period 422 for the second sensor count (SC2) is the same as the count for the second Master Count (MC2), and the first time period 322 for the first sensor count (SC1) will the same as the time period for the first Master Count (MC1). The unknown value for the number of host controller counts MC1 can be determined based on the ratios of the three known counts SC1, SC2, and MC2. That is, the ratio of MC1 to SC1 will be equal to or proportional to the ratio of MC2 to SC2, assuming clock stability over the first and second time periods. This is represented by equation (1) as follows:

$$\frac{MC 2}{SC 2} = \frac{MC 1}{SC 1} or \frac{MC 2}{MC 1} = \frac{SC 2}{SC 1} . \qquad ( 1 )$$

Accordingly, solving for MC1 yields equation (2) as follows:

MC1=MC2×SC1/SC2 (2).

Equation (2) then provides the count of the host controller's internal clock cycles over the first time period 322, which is represented in terms of the number of host controller clock cycles. Accordingly, because the host controller establishes the master reference timestamp MREF (see 320) at the issuance of the first event 314, the MTS timestamp can be found from the subtraction of the determined count MC1 from the timestamp MREF. Since MC1 can be expressed in terms of MC2, SC1, and SC2 as given in equation (2) above, the MTS timestamp of the sensor sample 304 as expressed in the controller's time units, may be calculated using equation (3) as follows:

MTS=MREF−MC2×SC1/SC2 (3).

From equation (3) above, the host controller is then able to determine a timestamp MTS that is the same as the timestamp of the sensor sample event 304 (or any other event where a sensor is configured to timestamp the event and issue a subsequent interrupt request) determined and assigned by the host controller, giving the host controller an accurate accounting of the timing.

Of further note, if the interrupt request (e.g., IRQ or IBI) is not immediately accepted by the host controller, the hardware events 314 and 316 will not issue unless the interrupt is accepted. Nonetheless, a sensor may be further configured to continue counting its own counter and wait for the next opportunity to have the interrupt request accepted. When the interrupt request is finally accepted, the sensor may be configured to proceed according to the processes as described above. It is noted in such case that the count of the first time period may be much greater than the count of the second time period, as the sensor continues counting as it waits for the interrupt request to be accepted and the subsequent hardware events 314, 316 to be issued. Although FIGS. 3 and 4 appear to illustrate that the first time period 322 and the second time period 422 are roughly equal, this is not necessarily the case and those skilled in the art will appreciate that equation (3) above provides the correct timestamp regardless of the difference (or the degree of difference) between the counts over the respective two time periods 322 and 422.

According to other aspects, alternate means for retrieving the timestamp data from the sensor beyond a predetermined payload inclusion as part of an interrupt request may include the host controller issuing a directed command or message for retrieving the data from the sensors. In such case, the sensor may be configured to issue a supplementary confirmation that the timestamp data has been collected, to which the host controller may issue the directed command to retrieve that data from the sensor.

Of further note, it will be appreciated that if the count numbers from the sensor are zero, the host controller will assess that no timestamp is assigned to the event, whereas if the count numbers are non-zero, then the host controller will proceed with calculating the real timestamp (MTS) using its own timer counter. Additionally, any suitable clock, either permanent or burst, may be used as the sensor clock, as long as it is sufficiently stable during the first and second time periods 322 and 422. As these time periods are generally short, the sensor clock may in some aspects be as simple as an RC oscillator or a ring oscillator. Additionally, it is noted that the illustrated frequencies or cycles per unit time of the sensor and host controller's clock signals are merely exemplary, and frequencies of the internal clocks and their frequencies relative to one another are not necessarily limited to those illustrated in the figures.

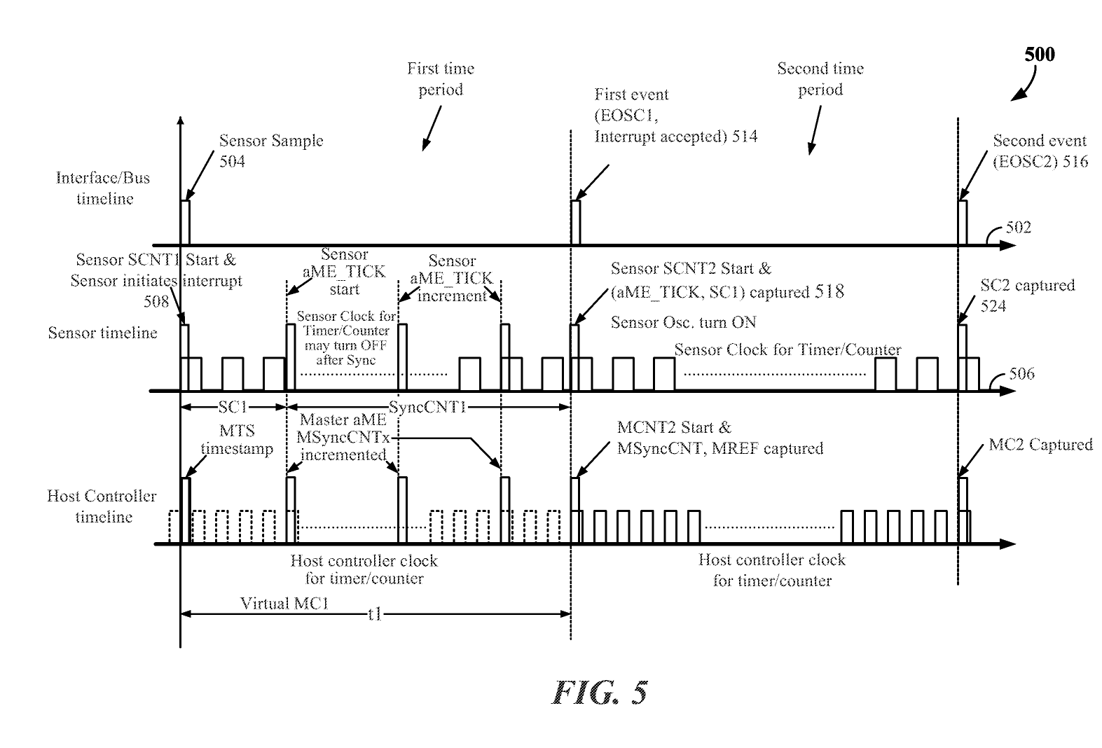

FIG. 5 illustrates an exemplary timeline diagram 500 showing sensor and host controller timestamping according to a second asynchronous mode (e.g., Async Mode 1). Similar to FIG. 3, the disclosed methodology of FIG. 5 employs the use of hardware events issued by the host controller (e.g., host controller device 202 in FIG. 2) on the bus or interface (e.g., interface 218 in FIG. 2) after an asynchronous event (e.g., random or unexpected event) on the bus occurs, such as a sensor sample.

As may be seen at a top timeline 502, which illustrates a timeline of events on the bus or interface, a sensor sample 504, which may be a random or unexpected sample, occurs at a particular time on the timeline 502. In an aspect, the sensor issuing the sample 504 may be configured to start a counter or timer of an internal sensor clock when a particular events occur (e.g., issuance of sensor sample 504). Accordingly, an internal sensor timeline 506 shows that the sensor issuing sample 504 starts a counter or timer (termed Sensor Count 1 or “SCNT1”) at the time of the sensor sample 504 being transmitted on the interface or bus. According to one example, the counter or timer SCNT1 (as well as the other timers to be discussed herein) may be implemented with a register, termed herein as a “timer register.” The start of count SCNT1 is illustrated by a pulse 508. Additionally, the sensor is configured to issue an interrupt or message to the host controller at the same time as the sensor sample 504 as also illustrated by the pulse 508 to indicate that the sensor has issued the sensor sample 504. The interrupt or message may be an interrupt request (IRQ) in I2C interfaces or an in-band interrupt (IBI) request in I3C interfaces.

In an aspect, the host controller is configured to send first and second events 514 and 516 to the sensor separated in time on the bus or interface. An event may be predetermined or in some similar way mutually identifiable by the sensor and the host controller, and may be referred to as a hardware time synchronization event (HWSE) or a master-initiated hardware end-of-count (EOSC). Accordingly, the sensor may start a counter (SCNT1) 508 at the sensing of an asynchronous event 504 and ends the counter at the issuance of a first master-initiated hardware event (EOSC1) 514, where the sensor records/captures a first count of clock pulses or a first sensor count (SC1) 518. Thereafter, the sensor starts another counting SCNT2 518 that ends at the issuance of a second master-initiated hardware event (EOSC2) 516, where the sensor records/captures a second count of clock pulses or a second sensor count (SC2) 524.

In an aspect of the disclosure, a system design for complex applications within a number of fields (e.g., mobile field and Internet of Things (IoT) field) may utilize several devices. Some of the devices may be sensors while other devices may be consumers of data acquired by the sensors. A consumer of data acquired by a sensor may be hereinafter referred to as a “host”.

A sensor may be used to capture (or sample) data with respect to real-life events. The sensor may be, for example, an accelerometer, a magnetometer, a gyroscope, a temperature sensor, a chemical sensor, etc. The data collected by the sensor is aggregated, evaluated, an analyzed by the host, ultimately allowing the host to reconstruct an event of a higher degree of complexity.

A “timestamp” may refer to the moment a real-life event is captured (or sampled) by the sensor. The timestamp is essential for the aggregation of event data. However, determining the timestamp at the host may present some complexity since a sensor timer and a host timer may not be aligned, either in frequency or in phase. Consequently, there is a need for aligning sensor and host timelines.

Among the events sampled by the sensor, the class of asynchronous events is significant. In such cases, the sensor samples, or is aware of, a specific event and transfers that information to the host. The sensor further facilitates a procedure that allows the host to reconstruct the timestamp of the specific event. There may be several ways of calculating the timestamp with regard to the host's timeline. Examples of procedures and methods for calculating the timestamp are described above with respect to FIGS. 3-5.

In an aspect of the disclosure, asynchronous event timestamping may need to cover a rather widely variable time domain while using base clocks and digital numbers. In some applications, the accuracy of the timestamp is of major importance, while in other applications, the latency of the timestamp calculating process takes precedence.

Sections of the MIPI I3C bus specification allow for the reconstruction of an asynchronous event timestamp with reference to a master/host timeline. The sections involved relate to asynchronous systems and events, namely an asynchronous basic mode (Async Mode 0) and an asynchronous advanced mode (Async Mode 1). In both Async Mode 0 and Async Mode 1, a slave starts a counter at the sensing of an event and ends the counter at the issuance of a first master-initiated hardware event (EOSC1), where the slave records/captures a count of clock pulses or a first sensor count (SC1). Thereafter, the slave starts another counting that ends at the issuance of a second master-initiated hardware event (EOSC2), where the slave records/captures a second count of clock pulses or a second sensor count (SC2). See FIGS. 3 and 5.

In an aspect, a degree of obtainable accuracy of the reconstructed timestamp may depend on: 1) a frequency of the driving clock of the timer/counter; 2) a time between the asynchronous event and the first master-initiated hardware event (EOSC1); and 3) a time between the first master-initiated hardware event (EOSC1) and the second master-initiated hardware event (EOSC2). The MIPI I3C bus specification describes a method of reading a typical central frequency of the sensor's clock that drives a timer/counter and an inaccuracy figure of merit. These two pieces data information may be provided via GETXTIME, an I3C Common Command Code (CCC). GETXTIME includes four bytes of data, out of which two bytes are: 1) a frequency byte; and 2) an inaccuracy byte.

The frequency byte is a slave's internal oscillator frequency, which may be expressed in 0.5 MHz (500 KHz) increments up to 127.5 MHz. The slave's clock frequency may be hereinafter referred to as “fCLKslave” for either the frequency byte or the real value.

The inaccuracy byte is a maximum variation of the slave's internal oscillator, which may be expressed in 1/10th percent (0.1%) increments up to 25.5%. The inaccuracy byte is a statistical element that has no direct usage for determining a more precise timestamp. As such, the presence of the inaccuracy byte may be an inefficient use of software and hardware space on both the slave and the master.

A required timestamp accuracy may be specified by an application. Based on this target, a system can make choices as to the procedure used for an optimized result. The final accuracy of the timestamp may not be better than the period of the driving clock. Accordingly, there is a need to provide an algorithm for optimally determining which timestamp reconstruction procedure is to be applied for reconstructing the timestamp of an asynchronous event. Such algorithm should use as few information bytes as possible to increase an efficiency of the procedure.

In an aspect of the disclosure, an algorithm is provided based on use case scenarios, as encountered within real-life applications, where the MIPI I3C bus interface is used. The algorithm covers a range of applications, indicating forking points, their deciding criteria, and subsequent procedures. Three use case scenarios are described below.

In a first scenario, a short time exists between the asynchronous event and the first master-initiated hardware event (EOSC1). If a time between the asynchronous event and the first master-initiated hardware event (EOSC1) is in a range close to a small multiple of a required timestamp resolution, then the timestamp can be determined by multiplying the first sensor count (SC1) with the slave's clock period. Even if the frequency of the driving clock is known with a certainty of +/−10%, the timestamp will still result with a stated accuracy.

For example, if a slave clock frequency (fCLKslave)=100 kHz, then a slave clock period (TCLKslave)= 1/100 kHz=10 μs. Moreover, a clock stated accuracy=+/−10%, a required timestamp resolution (TSres)=10 μs, and a time between the asynchronous event and the first master-initiated hardware event EOSC1 (EOSC1time)=50 μs.

Accordingly, if the first sensor count (SC1)=5, then a calculated delay using SC1 and TCLKslave is determined by SC1×TCLKslave=5×10 μs=50 μs. Moreover, a possible error (ERR)=+/−10%×EOSC1time=0.1×50 μs=5 μs. Hence, the ERR of 5 μs is smaller than the target timestamp resolution (TSres) of 10 μs.

Notably, the error may have two components: the resolution of the clock (TCLKslave) and the clock accuracy. The error calculation above considers an example where the resolution of the clock did not contribute. If added to the error calculation, the resolution of the clock may contribute another +/−5 μs to the error. This component of the error may be reduced by increasing the clock frequency, hence decreasing the clock period.

In view of the above, it may be seen that a large contributor to the resultant accuracy of the timestamp is given by the product of the clock stated accuracy and the time between the asynchronous event and the first master-initiated hardware event EOSC1 (EOSC1time). Hence, if the EOSC1time was 100 μs, the error caused by the clock accuracy would be +/−10%×EOSC1time=0.1×100 μs=10 μs.

In a second scenario, a relatively long time exists between the asynchronous event and the first master-initiated hardware event (EOSC1). If a time between the asynchronous event and the first master-initiated hardware event (EOSC1) is significantly longer than a required timestamp resolution, then the second master-initiated hardware event (EOSC2) may be delayed such that a quantization error consequent to the second sensor count (SC2) would result in a suitable timestamp resolution.

For example, if a clock frequency fCLKslave=5 MHz, then a clock period (TCLKslave)=⅕ MHz=200 ns. Moreover, a clock stated accuracy=+/−10%, a required timestamp resolution (TSres)=10 μs, a time between the asynchronous event and the first master-initiated hardware event EOSC1 (EOSC1time)=1 ms, and a non-adjusted time from the first master-initiated hardware event EOSC1 to the second master-initiated hardware event EOSC2 (EOSC2time)=1 μs.

Accordingly, an error component due to a TCLKslave quantization error may be ignored. In an example, the first sensor count (SC1)=1 ms/0.2 ns=5000, a non-adjusted second sensor count (SC2)=1 μs/0.2 ns=5, a non-adjusted second sensor count (SC2) quantization error=+/−1=>⅕=20%, and a non-adjusted second sensor count (SC2) based ideal calculated delay=(5000/5)×1 μs=1 ms. As such, a non-adjusted second sensor count (SC2) based induced inaccuracy=(⅕)×(5000/5)×1 μs=200 μs, which is not acceptable as it is greater than the target timestamp resolution (TSres) of 10 μs.

In another example, a required second sensor count (SC2) maximum quantization error for achieving the target timestamp maximum error=10 μs/1 ms= 1/100=1%, a required minimum adjusted second sensor count (SC2)=1/1%=1/0.01=100, and a required second master-initiated hardware event (EOSC2) extension, ignoring the already available second sensor count (SC2) time=100×TCLKslave=100×200 ns=20 μs. As such, a final adjusted second sensor count (SC2) induced accuracy=( 1/100)×(5000/105)×21 μs=10 μs, which is acceptable as it is equal to the target timestamp resolution (TSres) of 10 μs.

In a third scenario, a master may calculate a slave's clock frequency by scaling the master's own counter/timer number against the slave's counter/timer number. Between the first master-initiated hardware event (EOSC1) and the second master-initiated hardware event (EOSC2), the master and slave count the pulses of their respective base clocks. The master's count is the second Master Count (MC2) and the slave's count is the second sensor count (SC2). The master knows its own clock frequency fCLKmaster, and may use such value to directly calculate the slave's real clock frequency fCLKslave using the formula: fCLKslave=fCLKmaster×(SC2/MC2).

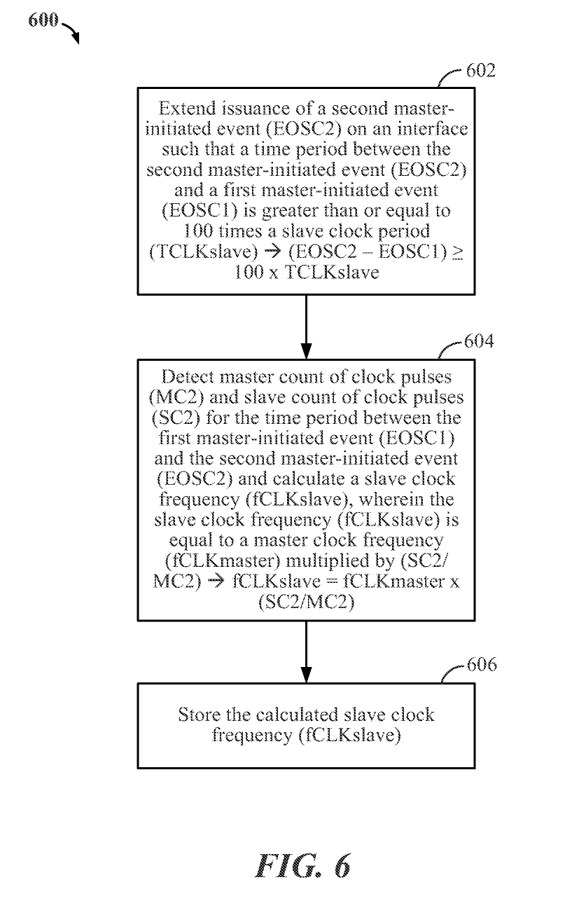

FIG. 6 is a diagram 600 illustrating an algorithm for evaluating a slave's clock frequency. At a first instance of an asynchronous event signaled by a sensor (slave), a master may extend the issuance of a second master-initiated event (EOSC2) on an interface by a suitable time period 602. For example, based on a frequency byte, the extension may cover at least 100 pulses, resulting in less than a 1% quantization error. As such, the master may extend the issuance of the second master-initiated event (EOSC2) such that a time period between the second master-initiated event (EOSC2) and a first master-initiated event (EOSC1) is greater than or equal to 100 times a slave clock period (TCLKslave): (EOSC2−EOSC1)≥100×TCLKslave. An extension period may be limited by I3C specifications to 100 μs. Such a period may accommodate the sensor's clock frequency higher than 1 MHz. If the sensor's clock is slower, a relative precision will decline accordingly.

The master may then scale the sensor's clock frequency 604, as described above. That is, the master may detect a master's count of clock pulses (MC2) and a slave's count of clock pulses (SC2) for the time period between the first master-initiated event (EOSC1) and the second master-initiated event (EOSC2) and calculate a slave's clock frequency (fCLKslave). The slave's clock frequency (fCLKslave) is equal to the master's known clock frequency (fCLKmaster) multiplied by the slave's count of clock pulses (SC2) for the time period between EOSC1 and EOSC2 and divided by the master's count of clock pulses (MC2) for the time period between EOSC1 and EOSC2. That is, fCLKslave=fCLKmaster×(SC2/MC2). Thereafter, the master may store the calculated slave's clock frequency fCLKslave 606.

In an aspect, the master may scale the sensor's clock frequency at rare intervals. For example, the scaling may be performed after an established number of asynchronous events have been processed. Depending on the application, the scaling may be performed once for every 128 events, or any other number of events. The scaling procedure described above may provide the slave's central clock frequency adjusted with respect to process/voltage/temperature (PVT) and aging.

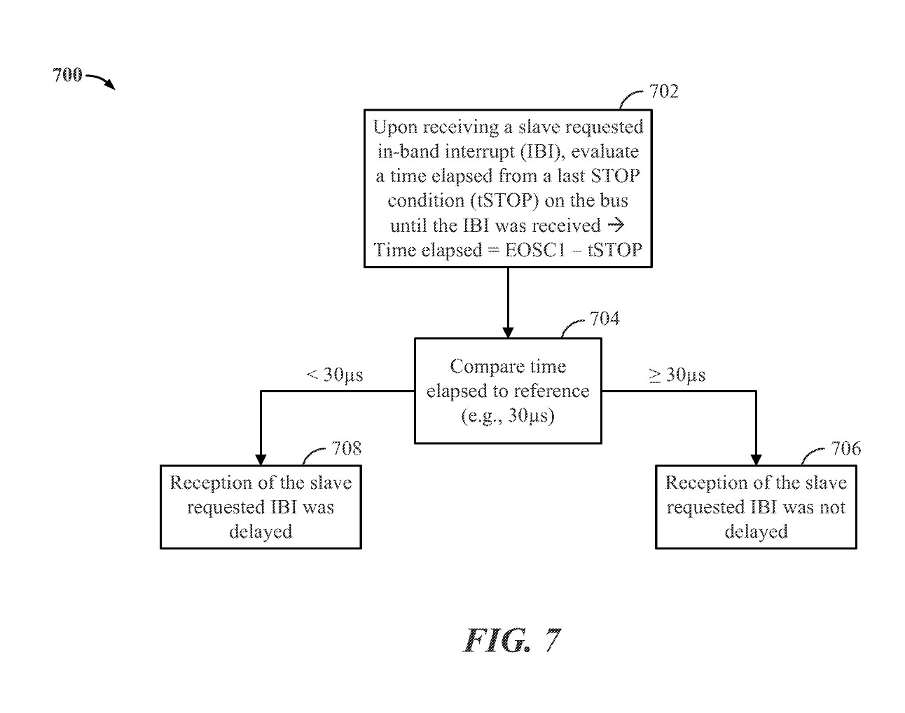

FIG. 7 is a diagram 700 illustrating an algorithm for evaluating a time exhausted between an asynchronous event and a first master-initiated event (EOSC1) on the interface. Upon receiving an in-band interrupt (IBI) request, a master may evaluate a time elapsed from a last STOP condition on the I3C bus until the active (IBI) request was received (Time elapsed=EOSC1−tSTOP) 702. Thereafter, the master compares the time elapsed to a reference 704. An I3C “bus available” condition reference may be used for comparison, with an engineering margin. The I3C “bus available” condition is specified in the I3C specification as 1 μs. Only past that delay can a slave initiate an IBI. Considering a safety margin and a demanding timestamp error, e.g., 10 μs, a reference may be chosen within an interval of 10 μs to 30 μs. Notably, this interval is merely an example as other interval ranges may be chosen according to the particular requirements of an application.

If the time elapsed (EOSC1−tSTOP) is equal to or greater than the reference (e.g., ≥30 μs), then it is implied that the reception of the slave requested IBI was not delayed by bus activity, nor by the slave's own tasks. Therefore, the signaled asynchronous event occurred very close to the moment the IBI request was received from the slave (close to EOSC1) 706. Consequently, the master may calculate the event timestamp using a first operation, as will be described below.

If the time elapsed (EOSC1−tSTOP) is less than the reference (e.g., <30 μs), then it is implied that the reception of the slave requested IBI was possibly delayed by previous activity on the bus 708. In such a case, the master may calculate the event timestamp using a second operation, as will be described below.

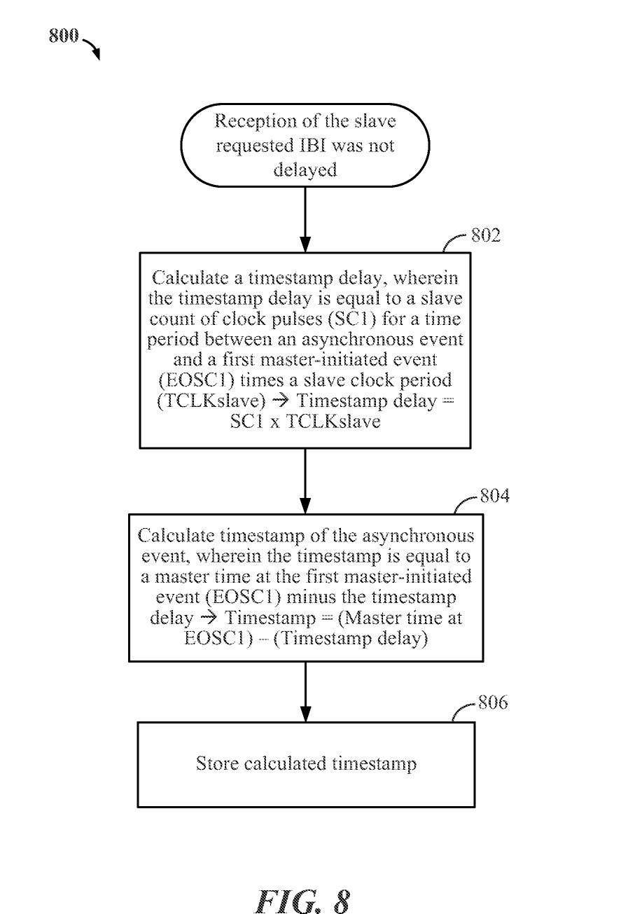

FIG. 8 is a diagram 800 illustrating a first operation for evaluating a timestamp of an asynchronous event that occurs near a first master-initiated event (EOSC1) on the interface, i.e., the reception of the slave requested IBI was not delayed. If the asynchronous event occurs near the first master-initiated event (EOSC1), the master may first calculate a timestamp delay 802. The timestamp delay is equal to a slave count of clock pulses (SC1) for a time period between the asynchronous event and the first master-initiated event (EOSC1) times a slave clock period (TCLKslave). That is, the Timestamp delay=SC1×TCLKslave. Thereafter, the master may calculate the timestamp of the asynchronous event 804. The timestamp is equal to a master time at the first master-initiated event (EOSC1) minus the timestamp delay. That is, the Timestamp=(Master time at EOSC1)−Timestamp delay. Finally, the master may store the calculated timestamp 806.

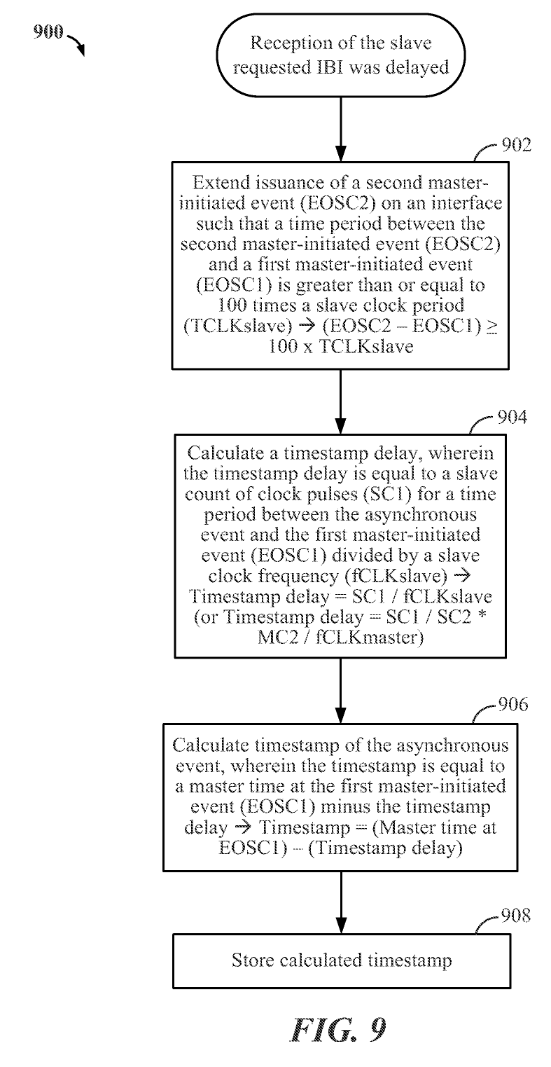

FIG. 9 is a diagram 900 illustrating a second operation for evaluating a timestamp of an asynchronous event where the reception of the slave requested IBI is significantly delayed. If the reception of the slave requested IBI is delayed, then the issuance of the first master-initiated event (EOSC1) on the interface is consequently delayed. Accordingly, based on a frequency byte, the master may extend the issuance of the second master-initiated event (ESOC2) on the interface to allow for a suitable quantization error, e.g., 1%. The operation may take several refinements, most notably related to the estimated delay of the event. At the least data throughput of the I3C bus, i.e., 10 Mbps at a single data rate (SDR mode), 1 kB of data may be transferred in 1 ms. However, a double data rate (DDR) mode ternary mode may be used for transferring a large amount of data. If the DDR mode or ternary mode is used, 1 ms may suffice to transfer 2 kB of data for the DDR mode or 3.3 kB of data for the ternary mode.

Based on the above, the procedure described below with respect to FIG. 9 may provide a timestamp delay accuracy of better than 10 μs. The master may calculate an extension for issuing the second master-initiated event (EOSC2) by ignoring an already available SC2 time (slave's count of clock pulses for the time period between the first master-initiated event (EOSC1) and the second master-initiated event (EOSC2)), which may be equal to 100×TCLKslave. For example, the master may first extend the issuance of the second master-initiated event (EOSC2) such that a time period between the second master-initiated event (EOSC2) and the first master-initiated event (EOSC1) is greater than or equal to 100 times a slave clock period (TCLKslave): (EOSC2−EOSC1)≥100×TCLKslave 902.

Thereafter, the master may calculate a timestamp delay 904. The timestamp delay is equal to a slave's count of clock pulses (SC1) for a time period between the asynchronous event and the first master-initiated event (EOSC1) divided by the slave's clock frequency (fCLKslave). That is, Timestamp delay=SC1/fCLKslave. As discussed above, the slave's clock frequency (fCLKslave) is equivalent to the master's known clock frequency (fCLKmaster) multiplied by the slave's count of clock pulses (SC2) for the time period between EOSC1 and EOSC2 and divided by the master's count of clock pulses (MC2) for the time period between EOSC1 and EOSC2. That is, fCLKslave=fCLKmaster×(SC2/MC2). Accordingly, the timestamp delay may also be given by: Timestamp delay=SC1/SC2×MC2/fCLKmaster.

The master may then calculate the timestamp of the asynchronous event 906. The timestamp is equal to a master time at the first master-initiated event (EOSC1) minus the timestamp delay. That is, the Timestamp=(Master time at EOSC1)−Timestamp delay. Finally, the master may store the calculated timestamp 908.

In an aspect of the disclosure, the algorithms described above allow for reduced latency in calculating a timestamp of an interface event based on when the IBI is received from a sensor. If reception of the IBI is not delayed, the first operation (FIG. 8) for evaluating the timestamp may be utilized. In the first operation, a less number of variables are used to calculate the timestamp, and therefore, the timestamp may be calculated in a less amount of time. If reception of the IBI is delayed, the second operation (FIG. 9) for evaluating the timestamp may be utilized. In the second operation, a greater number of variables are used, and therefore, a more precise timestamp may be calculated. Accordingly, the algorithms above may be implemented in applications where the latency of the timestamp calculating process takes precedence and/or the accuracy of the timestamp is of major importance.

In an aspect of the disclosure, the algorithm(s) described above for evaluating the timestamp of an asynchronous event may be simplified. For example, in cases where the requirements for timestamp accuracy are relaxed, the frequency scaling procedure and/or the EOSC2 extension described above may not be necessary. In another example, if a slave's clock generator is relatively stable, e.g., based on a crystal or MEMS structure, then the frequency scaling procedure may be performed less often.

The algorithm(s) described above allows for the estimation of the timestamp of asynchronous events with increased accuracy, over the PVT and aging of the devices involved. At the same time, the algorithm(s) avoids the usage of the inaccuracy byte of the I3C Common Command Code (CCC) GETXTIME, saving software and hardware space.

### Examples of a Method, Apparatus, and Processing Circuit

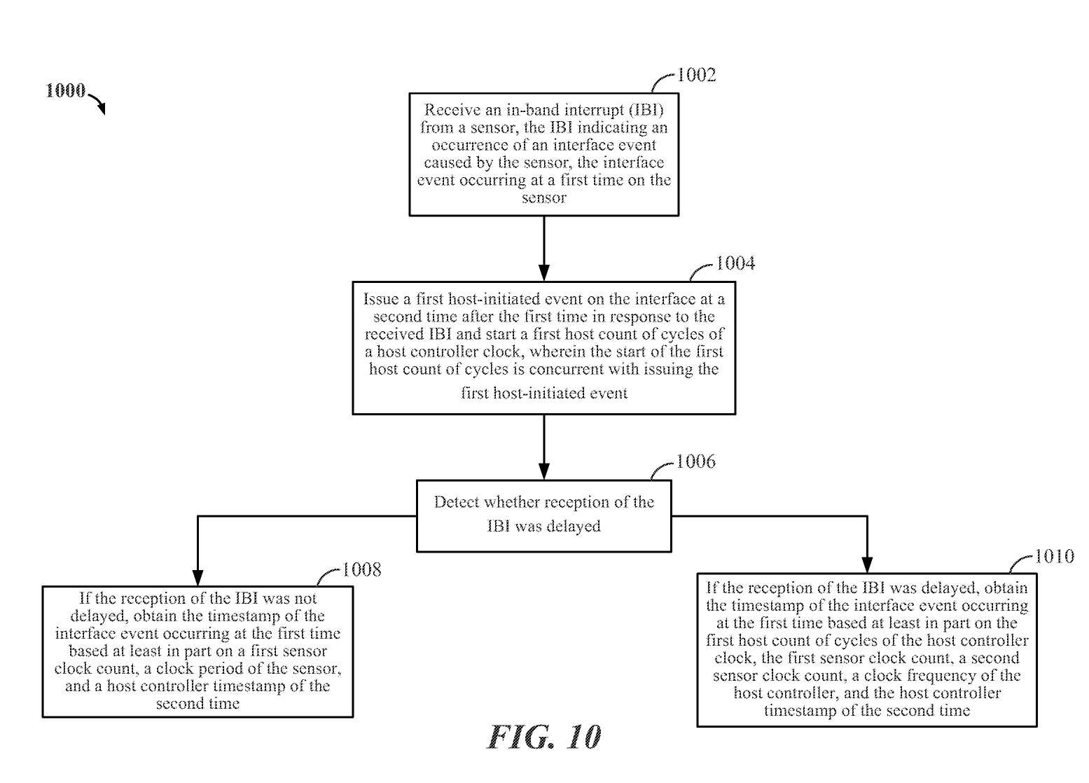

FIG. 10 is a flowchart illustrating an exemplary method 1000 for obtaining a timestamp of an interface event occurring on an interface. In an aspect, the method 1000 may be implemented by a host controller, such as host controller 202 as one example.

The host controller may receive an interrupt request (e.g., IBI) from a sensor 1002. The interrupt request may indicate an occurrence of an interface event (e.g., asynchronous event) caused by the sensor. Moreover, the interface event may occur at a first time on the sensor.

The host controller may issue a first host-initiated event (e.g., EOSC1) on the interface at a second time after the first time in response to the received interrupt request and start a first host count of cycles (e.g., MC2) of a host controller clock 1004. The starting of the first host count may be concurrent with issuing the first host-initiated event.

The host controller may detect whether reception of the interrupt request was delayed 1006. Detecting whether reception of the interrupt request was delayed may include obtaining a time elapsed from a last stop condition on the interface to when the interrupt request was received (e.g., EOSC1−tSTOP). Thereafter, the host controller may compare the time elapsed to a reference time (e.g., 10 μs to 30 μs). If the comparing results in the time elapsed being greater than or equal to the reference time, then the host controller may detect that the reception of the interrupt request was not delayed. However, if the comparing results in the time elapsed being less than the reference time, then the host controller may detect that the reception of the interrupt request was delayed.

If the reception of the interrupt request was not delayed, then the host controller may obtain the timestamp of the interface event occurring at the first time based at least in part on a first sensor clock count (e.g., SC1), a clock period of the sensor (e.g., TCLKslave), and a host controller timestamp of the second time (e.g., Master time at EOSC1) 1008.

For example, if the reception of the interrupt request was not delayed, the host controller may obtain the timestamp by receiving the first sensor clock count from the sensor, wherein the first sensor clock count is a first sensor count of cycles of an internal sensor clock from the first time to the second time, calculating a timestamp delay as a product of the first sensor clock count and the clock period of the sensor, and obtaining the timestamp by subtracting the timestamp delay from the host controller timestamp of the second time.

If the reception of the interrupt request was delayed, then the host controller may obtain the timestamp of the interface event occurring at the first time based at least in part on the first host count of cycles of the host controller clock (e.g., MC2), the first sensor clock count (e.g., SC1), a second sensor clock count (e.g., SC2), a clock frequency of the host controller (e.g., fCLKmaster), and the host controller timestamp of the second time (e.g., Master time at EOSC1) 1010.

For example, if the reception of the interrupt request was delayed, the host controller may obtain the timestamp by issuing a second host-initiated event (e.g., EOSC2) on the interface at a third time after the second time, receiving the first sensor clock count from the sensor, wherein the first sensor clock count is a first sensor count of cycles of an internal sensor clock from the first time to the second time, and receiving the second sensor clock count from the sensor, wherein the second sensor clock count is a second sensor count of cycles of the internal sensor clock from the second time to the third time. The host controller may further obtain the timestamp by calculating a timestamp delay according to the relationship: Timestamp delay=(First sensor clock count/Second sensor clock count)×(First host count of cycles of the host controller clock/Clock frequency of the host controller), and obtaining the timestamp by subtracting the timestamp delay from the host controller timestamp of the second time.

In an aspect, the second host-initiated event (e.g., EOSC2) on the interface may be issued at the third time according to the relationship: (Third time−Second time)≥(100×Clock period of the sensor). Moreover, each of the first host-initiated event and the second host-initiated event includes a predetermined hardware event known to both the host controller and the sensor.

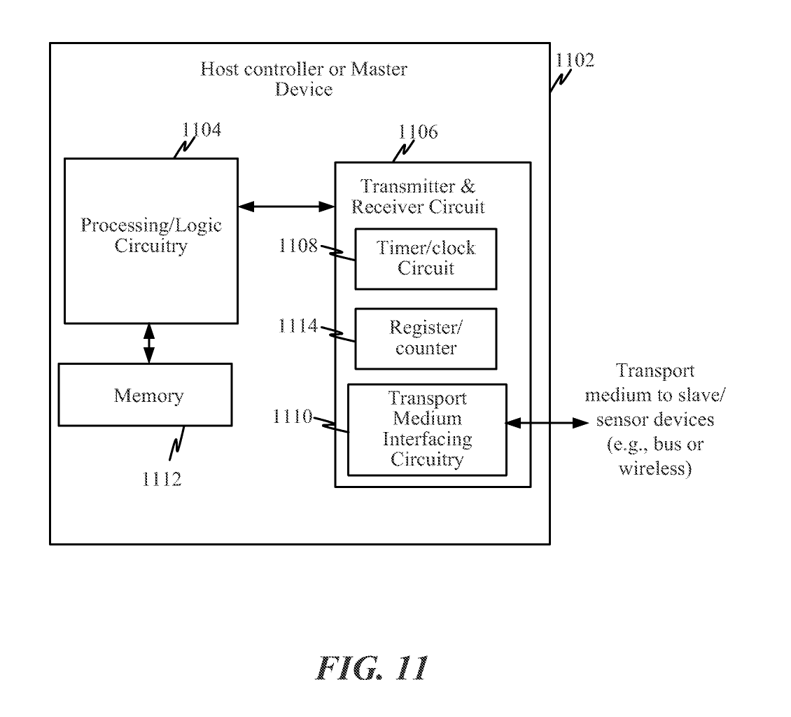

FIG. 11 illustrates an exemplary host controller device or master device 1102 that may include processing or logic circuitry 1104 coupled with a transmitter/receiver circuitry 1106 for transmitting and receiving signals, commands, and data on a bus interface or circuit communicatively coupled with at least slave or sensor devices. The transmitter/receiver circuitry 1106 may include a timer or clock circuitry 1108 used at least for internal timing for the host controller device 1102. It is noted that although timer or clock circuitry 1108 is illustrated within the transmitter/receiver circuit 1106, this circuitry or function may be implemented instead within the processing/logic circuitry 1104. Although not shown, the host controller device 1102 may also employ other clocking or timing devices for internal clocking, such as clocking for the processing circuitry 1104, as an example. Further, the transmitter/receiver circuitry 1106 also includes a transport medium interfacing circuit 1110 configured to interface the transmitter/receiver circuitry with the physical interface, which may be a transport medium such as an I2C or I3C bus, as examples. Furthermore, the transport medium interface may employ at least two lines such as an SDA line and SCL line, but could include further lines as discussed earlier with respect to interface 218 in FIG. 2.

The host controller device 1102 also may include a memory device or storage medium 1112 coupled with at least the processing circuitry 1104 and include code or one or more instructions for causing the circuitry 1104 to implement or direct the transmitter/receiver circuit 1106 to implement the various methodologies disclosed herein, such as those disclosed in connection with FIGS. 3-10.

In another aspect, the host controller device 1102 may include a register or some other counter 1114 that performs some or all of the functions of effecting the methods as disclosed in FIGS. 3-10. In particular, the counter 1114 is used to count cycles of the timer/clock circuit 1108 to derive the MC2 (e.g., clock cycles 330 as shown in FIG. 3). Additionally, it is noted here that the timer/clock circuit 1108 or the timer/clock circuit 1108 in conjunction with the processing/logic circuitry 1104 may be used to determine timestamps, such as the MREF timestamp discussed earlier.

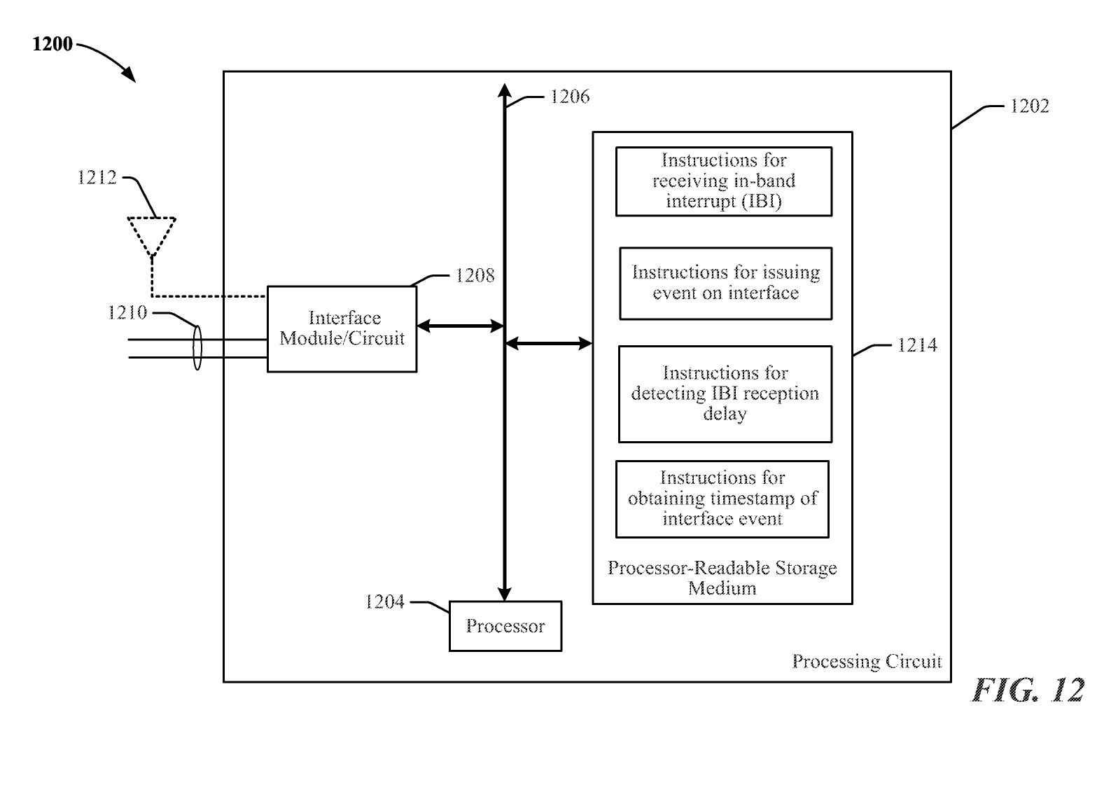

FIG. 12 is a diagram illustrating a simplified example of a hardware implementation for a host controller (host controller device) 1200 employing at least one processing circuit 1202. Examples of operations performed by the host controller 1200 include the operations described above with respect to the flow charts of FIGS. 6-10, as well as the timelines in FIGS. 3-5. The at least one processing circuit 1202 typically has a processor 1304 that may include one or more of a microprocessor, microcontroller, digital signal processor, a sequencer and a state machine. The at least one processing circuit 1202 may be implemented with a bus architecture, represented generally by the bus 1206. The bus 1206 may include any number of interconnecting buses and bridges depending on the specific application of the at least one processing circuit 1202 and the overall design constraints. The bus 1206 communicatively couples various circuits including one or more processors and/or hardware modules, represented by the processor 1204, and an interface module or circuit 1208 that is configurable to support communication over various connectors or wires 1210 operable according to various transport protocols or interfaces (as shown by optional antenna 1212) and a processor-readable storage medium 1214. The bus 1206 may also link various other circuits such as timing sources, peripherals, voltage regulators, and power management circuits, which are well known in the art, and therefore, are not described in detail herein. It is also noted that the interfaces may be one or more interfaces operable according to one or multiple transport formats, as well as being communicatively coupled to one or more slave/sensor devices or to other host controllers.

The processor 1204 is responsible for general processing, including the execution of software or one or more instructions stored on the processor-readable storage medium 1214. The software or one or more instructions, when executed by the processor 1204, causes the at least one processing circuit 1202 to perform the various functions described before for any particular apparatus. The computer or processor-readable storage medium 1214 may also be used for storing data that is manipulated by the processor 1204 when executing software, including data decoded from symbols transmitted over the connectors or wires 1210 or antenna 1212. The at least one processing circuit 1202 further includes at least one of the modules/circuits 1208, which may be software modules running in the processor 1204, resident/stored in the processor-readable storage medium 1214, one or more hardware modules coupled to the processor 1204, or some combination thereof. The modules/circuits 1208 may include microcontroller instructions, state machine configuration parameters, or some combination thereof.

In one configuration, the processor-readable medium 1214 includes instructions for receiving an in-band interrupt (IBI), which are configured to cause the processor 1304 to perform various functions including the processes illustrated in block 1002 of FIG. 10, for example. The processor-readable medium 1214 also includes instructions for issuing host-initiated events on the interface, which are configured to cause the processor 1204 to perform various functions including the processes illustrated in block 1004 of FIG. 10, for example. Additionally, the processor readable medium 1214 also includes instructions for detecting an IBI reception delay which are configured to cause the processor 1204 to perform various functions including the processes illustrated in block 1006 of FIG. 10, for example. Finally, the processor readable medium 1214 also includes instructions for obtaining a timestamp of an interface event, which are configured to cause the processor 1204 to perform various functions including the processes illustrated in blocks 1008 and 1010 of FIG. 10, for example.

Example methods, apparatus, or articles of manufacture presented herein may be implemented, in whole or in part, for use in or with mobile communication devices. As used herein, “mobile device”, “mobile communication device”, “hand-held device”, “tablets”, etc., or the plural form of such terms may be used interchangeably and may refer to any kind of special purpose computing platform or device that may communicate through transmission or receipt of information over suitable communications networks according to one or more communication protocols, and that may from time to time have a position or location that changes. As a way of illustration, special purpose mobile communication devices, may include, for example, cellular telephones, satellite telephones, smart telephones, heat map or radio map generation tools or devices, observed signal parameter generation tools or devices, personal digital assistants (PDAs), laptop computers, personal entertainment systems, e-book readers, tablet personal computers (PC), personal audio or video devices, personal navigation units, or the like. It should be appreciated, however, that these are merely illustrative examples relating to mobile devices that may be utilized to facilitate or support one or more processes or operations described herein.

In at least some implementations, one or more portions of the herein described storage media may store signals representative of data and/or information as expressed by a particular state of the storage media. For example, an electronic signal representative of data and/or information may be “stored” in a portion of the storage media (e.g., memory device) by affecting or changing the state of such portions of the storage media to represent data and/or information as binary information (e.g., ones and zeroes). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory device of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm here, and generally, is considered to be a self-consistent sequence of operations or similar signal processing leading to a desired result. In this context, operations or processing involves physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing”, “computing”, “calculating”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

It is understood that the specific order or hierarchy of steps in the processes disclosed is merely an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of a host controller for obtaining a timestamp of an interface event occurring on an interface, comprising:
receiving an in-band interrupt (IBI) from a sensor, the IBI indicating an occurrence of an interface event caused by the sensor, the interface event occurring at a first time on the sensor;
issuing a first host-initiated event on the interface at a second time after the first time in response to the received IBI and starting a first host count of cycles of a host controller clock, wherein a start of the first host count of cycles is concurrent with issuing the first host-initiated event;
detecting whether reception of the IBI was delayed;
if the reception of the IBI was not delayed:
obtaining the timestamp of the interface event occurring at the first time based at least in part on a first sensor clock count, a clock period of the sensor, and a host controller timestamp of the second time; and
if the reception of the IBI was delayed:
obtaining the timestamp of the interface event occurring at the first time based at least in part on the first host count of cycles of the host controller clock, the first sensor clock count, a second sensor clock count, a clock frequency of the host controller, and the host controller timestamp of the second time.

2. The method of claim 1, wherein if the reception of the IBI was not delayed, obtaining the timestamp includes:
receiving the first sensor clock count from the sensor, wherein the first sensor clock count is a first sensor count of cycles of an internal sensor clock from the first time to the second time.

3. The method of claim 2, wherein obtaining the timestamp includes:
calculating a timestamp delay as a product of the first sensor clock count and the clock period of the sensor; and
obtaining the timestamp by subtracting the timestamp delay from the host controller timestamp of the second time.

4. The method of claim 1, wherein if the reception of the IBI was delayed, obtaining the timestamp includes:
issuing a second host-initiated event on the interface at a third time after the second time;
receiving the first sensor clock count from the sensor, wherein the first sensor clock count is a first sensor count of cycles of an internal sensor clock from the first time to the second time; and
receiving the second sensor clock count from the sensor, wherein the second sensor clock count is a second sensor count of cycles of the internal sensor clock from the second time to the third time.

5. The method of claim 4, wherein obtaining the timestamp includes:
calculating a timestamp delay according to a relationship: the timestamp delay is equal to the first sensor clock count divided by the second sensor clock count multiplied by the first host count of cycles of the host controller clock divided by the clock frequency of the host controller; and
obtaining the timestamp by subtracting the timestamp delay from the host controller timestamp of the second time.

6. The method of claim 4, wherein the second host-initiated event on the interface is issued at the third time according to a relationship: the third time minus the second time is greater than or equal to one-hundred times the clock period of the sensor.

7. The method of claim 4, wherein each of the first host-initiated event and the second host-initiated event includes a predetermined hardware event known to both the host controller and the sensor.

8. The method of claim 1, wherein detecting whether reception of the IBI was delayed includes:
obtaining a time elapsed from a last stop condition on the interface to when the IBI was received;
comparing the time elapsed to a reference time;
detecting that the reception of the IBI was not delayed if the time elapsed is greater than or equal to the reference time; and
detecting that the reception of the IBI was delayed if the time elapsed is less than the reference time.

9. A host controller device configured to obtain a timestamp of an interface event occurring on an interface, comprising:
an interface coupled to a sensor via a transport medium; and
at least one processing circuit coupled to the interface and configured to:
receive an in-band interrupt (IBI) from the sensor, the IBI indicating an occurrence of an interface event caused by the sensor, the interface event occurring at a first time on the sensor,
issue a first host-initiated event on the interface at a second time after the first time in response to the received IBI and start a first host count of cycles of a host controller clock, wherein a start of the first host count of cycles is concurrent with issuing the first host-initiated event,
detect whether reception of the IBI was delayed,
if the reception of the IBI was not delayed:
obtain the timestamp of the interface event occurring at the first time based at least in part on a first sensor clock count, a clock period of the sensor, and a host controller timestamp of the second time, and
if the reception of the IBI was delayed:
obtain the timestamp of the interface event occurring at the first time based at least in part on the first host count of cycles of the host controller clock, the first sensor clock count, a second sensor clock count, a clock frequency of the host controller device, and the host controller timestamp of the second time.

10. The host controller device of claim 9, wherein if the reception of the IBI was not delayed, the at least one processing circuit configured to obtain the timestamp is further configured to:
receive the first sensor clock count from the sensor, wherein the first sensor clock count is a first sensor count of cycles of an internal sensor clock from the first time to the second time.

11. The host controller device of claim 10, wherein the at least one processing circuit configured to obtain the timestamp is further configured to:
calculate a timestamp delay as a product of the first sensor clock count and the clock period of the sensor; and
obtain the timestamp by subtracting the timestamp delay from the host controller timestamp of the second time.

12. The host controller device of claim 9, wherein if the reception of the IBI was delayed, the at least one processing circuit configured to obtain the timestamp is further configured to:
issue a second host-initiated event on the interface at a third time after the second time;
receive the first sensor clock count from the sensor, wherein the first sensor clock count is a first sensor count of cycles of an internal sensor clock from the first time to the second time; and
receive the second sensor clock count from the sensor, wherein the second sensor clock count is a second sensor count of cycles of the internal sensor clock from the second time to the third time.

13. The host controller device of claim 12, wherein the at least one processing circuit configured to obtain the timestamp is further configured to:
calculate a timestamp delay according to a relationship: the timestamp delay is equal to the first sensor clock count divided by the second sensor clock count multiplied by the first host count of cycles of the host controller clock divided by the clock frequency of the host controller device; and
obtain the timestamp by subtracting the timestamp delay from the host controller timestamp of the second time.

14. The host controller device of claim 12, wherein the second host-initiated event on the interface is issued at the third time according to a relationship: the third time minus the second time is greater than or equal to one-hundred times the clock period of the sensor.

15. The host controller device of claim 12, wherein each of the first host-initiated event and the second host-initiated event includes a predetermined hardware event known to both the host controller device and the sensor.

16. The host controller device of claim 9, wherein the at least one processing circuit configured to detect whether reception of the IBI was delayed is configured to:
obtain a time elapsed from a last stop condition on the interface to when the IBI was received;
compare the time elapsed to a reference time;
detect that the reception of the IBI was not delayed if the time elapsed is greater than or equal to the reference time; and
detect that the reception of the IBI was delayed if the time elapsed is less than the reference time.

17. A processor-readable storage medium having one or more instructions which, when executed by at least one processing circuit, cause the at least one processing circuit to:
receive, at a host controller, an in-band interrupt (IBI) from a sensor, the IBI indicating an interface event caused by the sensor occurring on an interface, the interface event occurring at a first time on the sensor;
issue a first host-initiated event on the interface at a second time after the first time in response to the received IBI and start a first host count of cycles of a host controller clock, wherein a start of the first host count of cycles is concurrent with issuing the first host-initiated event;
detect whether reception of the IBI was delayed;
if the reception of the IBI was not delayed:
obtain a timestamp of the interface event occurring at the first time based at least in part on a first sensor clock count, a clock period of the sensor, and a host controller timestamp of the second time; and
if the reception of the IBI was delayed:
obtain the timestamp of the interface event occurring at the first time based at least in part on the first host count of cycles of the host controller clock, the first sensor clock count, a second sensor clock count, a clock frequency of the host controller, and the host controller timestamp of the second time.

18. The processor-readable storage medium of claim 17, wherein if the reception of the IBI was not delayed, the at least one processing circuit caused to obtain the timestamp is further caused to:
receive the first sensor clock count from the sensor, wherein the first sensor clock count is a first sensor count of cycles of an internal sensor clock from the first time to the second time.

19. The processor-readable storage medium of claim 18, wherein the at least one processing circuit caused to obtain the timestamp is further caused to:
calculate a timestamp delay as a product of the first sensor clock count and the clock period of the sensor; and
obtain the timestamp by subtracting the timestamp delay from the host controller timestamp of the second time.

20. The processor-readable storage medium of claim 17, wherein if the reception of the IBI was delayed, the at least one processing circuit caused to obtain the timestamp is further caused to:
issue a second host-initiated event on the interface at a third time after the second time;
receive the first sensor clock count from the sensor, wherein the first sensor clock count is a first sensor count of cycles of an internal sensor clock from the first time to the second time; and
receive the second sensor clock count from the sensor, wherein the second sensor clock count is a second sensor count of cycles of the internal sensor clock from the second time to the third time.

21. The processor-readable storage medium of claim 20, wherein the at least one processing circuit caused to obtain the timestamp is further caused to:
calculate a timestamp delay according to a relationship: the timestamp delay is equal to the first sensor clock count divided by the second sensor clock count multiplied by the first host count of cycles of the host controller clock divided by the clock frequency of the host controller; and
obtain the timestamp by subtracting the timestamp delay from the host controller timestamp of the second time.

22. The processor-readable storage medium of claim 20, wherein the second host-initiated event on the interface is issued at the third time according to a relationship: the third time minus the second time is greater than or equal to one-hundred times the clock period of the sensor.

23. The processor-readable storage medium of claim 20, wherein each of the first host-initiated event and the second host-initiated event includes a predetermined hardware event known to both the host controller and the sensor.

24. The processor-readable storage medium of claim 17, wherein the at least one processing circuit caused to detect whether reception of the IBI was delayed is caused to:
obtain a time elapsed from a last stop condition on the interface to when the IBI was received;
compare the time elapsed to a reference time;
detect that the reception of the IBI was not delayed if the time elapsed is greater than or equal to the reference time; and
detect that the reception of the IBI was delayed if the time elapsed is less than the reference time.

25. A host controller device for obtaining a timestamp of an interface event occurring on an interface, comprising:
means for receiving an in-band interrupt (IBI) from a sensor, the IBI indicating an occurrence of an interface event caused by the sensor, the interface event occurring at a first time on the sensor;
means for issuing a first host-initiated event on the interface at a second time after the first time in response to the received IBI and starting a first host count of cycles of a host controller clock, wherein a start of the first host count of cycles is concurrent with issuing the first host-initiated event;
means for detecting whether reception of the IBI was delayed; and
means for obtaining the timestamp of the interface event,
wherein if the reception of the IBI was not delayed, the means for obtaining the timestamp is configured to:
obtain the timestamp of the interface event occurring at the first time based at least in part on a first sensor clock count, a clock period of the sensor, and a host controller timestamp of the second time, and
wherein if the reception of the IBI was delayed, the means for obtaining the timestamp is configured to:
obtain the timestamp of the interface event occurring at the first time based at least in part on the first host count of cycles of the host controller clock, the first sensor clock count, a second sensor clock count, a clock frequency of the host controller, and the host controller timestamp of the second time.

26. The host controller device of claim 25, wherein if the reception of the IBI was not delayed, the means for obtaining the timestamp is further configured to:
receive the first sensor clock count from the sensor, wherein the first sensor clock count is a first sensor count of cycles of an internal sensor clock from the first time to the second time;
calculate a timestamp delay as a product of the first sensor clock count and the clock period of the sensor; and
obtain the timestamp by subtracting the timestamp delay from the host controller timestamp of the second time.

27. The host controller device of claim 25, wherein if the reception of the IBI was delayed, the means for obtaining the timestamp is further configured to:
issue a second host-initiated event on the interface at a third time after the second time;
receive the first sensor clock count from the sensor, wherein the first sensor clock count is a first sensor count of cycles of an internal sensor clock from the first time to the second time;
receiving the second sensor clock count from the sensor, wherein the second sensor clock count is a second sensor count of cycles of the internal sensor clock from the second time to the third time;
calculate a timestamp delay according to a relationship: the timestamp delay is equal to the first sensor clock count divided by the second sensor clock count multiplied by the first host count of cycles of the host controller clock divided by the clock frequency of the host controller; and
obtain the timestamp by subtracting the timestamp delay from the host controller timestamp of the second time.

28. The host controller device of claim 27, wherein the second host-initiated event on the interface is issued at the third time according to a relationship: the third time minus the second time is greater than or equal to one-hundred times the clock period of the sensor.

29. The host controller device of claim 27, wherein each of the first host-initiated event and the second host-initiated event includes a predetermined hardware event known to both the host controller and the sensor.

30. The host controller device of claim 25, wherein the means for detecting whether reception of the IBI was delayed is configured to:
obtain a time elapsed from a last stop condition on the interface to when the IBI was received;
compare the time elapsed to a reference time;
detect that the reception of the IBI was not delayed if the time elapsed is greater than or equal to the reference time; and
detect that the reception of the IBI was delayed if the time elapsed is less than the reference time.
